(19) United States
(12) Patent Application Publication
(10) Pub. No.: US 2009/0100417 A1
(43) Pub. Date: Apr. 16, 2009

(54) Processor Controlled Device, in Particular Electronic Communication and/or Multimedia Device with Different Operation Modes

(75) Inventors: Wladyslaw Bolanowski, Bara (SE); Tobias Ritzau, Veberod (SE)

Correspondence Address: MYERS BIGEL SIBLEY & SAJOVEC, P.A., P.O. BOX 37428, RALEIGH, NC, 27627, US

(73) Assignee: SONY ERICSSON MOBILE COMMUNICATIONS AB, Lund (SE)

(21) Appl. No.: 11/916,741

(22) PCT Filed: May 31, 2006
(86) PCT No.: PCT/EP2006/005197

§ 371 Date: May 15, 2008

Related U.S. Application Data
(60) Provisional application No. 60/690,975, filed on Jun. 16, 2005.

(30) Foreign Application Priority Data
Jun. 10, 2005 (EP) 05012536.8

(51) Int. Cl. G06F 9/445; G06F 12/02; G06F 9/22

(52) U.S. Cl. 717/168; 711/103; 712/229; 711/E12.002; 712/E09.004

(57) ABSTRACT

An electronic communication and/or multimedia device comprises a central processing unit controlling the operation of said device, wherein in a standard mode the operation of the device is carried out on the basis of data stored in the first memory said device. In a reduced mode of said device, a part of the data stored in said first memory is copied into second memory wherein the operation of said device in said reduced mode is carried out only on the basis of the data contained in said second memory. Said reduced mode might be used for updating the software of the device while still providing a basis functionality.

### TECHNICAL FIELD OF THE INVENTION

The present invention relates to a processor controlled device, in particular to an electronic communication and/or multimedia device which comprises a central processing unit controlling the operation of the device wherein said device is operable in a plurality of different operation modes. Furthermore, the present invention relates to a method for operating an electronic communication and/or multimedia device. Said method might in particular be used for distributing and updating information or data contained in memory means of the device.

### DESCRIPTION OF RELATED ART

With the rapid and continuous advancement of software and hardware technology, maintenance of existing devices and software components presents an ever-increasing challenge. Routine installation of information updates and patches has become a recognised necessity to ensure that the devices are kept fully functional over the operational life times. Unfortunately, for many devices and applications update management is extremely time-consuming and often requires a temporary deactivation of the device.

If—for example—the device is a mobile phone, there are often scenarios in which the normal functionality of the phone is discontinued due to maintenance operations or some other kind of operation that is not possible to combine with the standard mode of the mobile phone operation. An example is the so-called firmware update over the air (FOTA) which is offered by cellular network operators in order to update the functionality of the phone. During the code update phase of an FOTA service, more or less the entire code stored in memory means of the phone is being updated in order to upgrade it to a newer software version. During this phase, the user has to wait until this update operation is completed before a normal use of the phone is again possible. In the case of an FOTA, depending on the kind of flash memory that is being used in the phone, the mobile phone is discontinued from said standard operation for a relative long time.

A possible solution in order to avoid this problem is the usage of code shadowing. In this case, the entire code is being copied from a flash memory of the phone to a RAM at the start-up of the phone. A normal operation of the phone is maintained by allowing a code execution from the RAM while a new software version is being prepared in the flash memory. However, in this case the problem might arise that the file system is as well an object for the upgrade through FOTA and must therefore be synchronised afterwards. The main problem, however, is that code shadowing is expensive since it requires as much RAM as the whole size of the code.

A more cost-efficient way to execute code from a RAM is the use of demand paging. This method reduces the RAM needed for code execution by 30-50% compared with code shadowing. However, in this case only a part of the code is loaded into RAM. In case a new function is started, a new page might be requested to be loaded from the flash memory while the flash memory is actually in a state of total reorganisation by FOTA.

The problem mentioned above arises not only with the usage of mobile phones. Generally, portable electronic devices often lack the ability to perform automated update operations in a convenient and reliable manner. Since, however, increased sophistication of updatable electronic devices and software often necessitates frequent maintenance where updates are made available and desirably applied on a weekly or monthly basis, there is a need for an improved update process that allows a reliable update of hardware and/or software systems without completely constricting the operation of the system.

### SUMMARY

The solution to this problem is based on the idea of providing an electronic device which is operable in a so-called reduced mode in which a part of the data or code defining the operation of the device is copied into a specific memory wherein the operation of the device in said reduced mode is generally only carried out on the basis of these copied data. In contrast to the known method of demand paging, the data that are necessary in order to run the reduced mode are completely identified at the initiation of the reduced mode and copied to the specific memory means. Thus, during the execution of the reduced mode it is not any longer necessary to access data that might be updated at the same time. The conflict situation mentioned above in relation with demand paging is therefore avoided.

Thus, in accordance with the present invention, a processor controlled device, in particular an electronic communication and/or multimedia device comprising a central processing unit controlling the operation of said device is provided wherein the normal operation of the device is carried out on the basis of data stored in first and/or second memory means of said device and wherein in a reduced mode of said device, a part of the data stored in said first memory means is copied into second memory means, said data being copied to the second memory means being identified at the initiation of said reduced mode, and wherein further the operation of said device in said reduced mode is basically carried out only on the basis of the data contained in said second memory means. Furthermore, a method of operating a processor controlled device, in particular an electronic communication and/or multimedia device is provided wherein the normal operation of the device is carried out on the basis of data stored in first and/or second memory means of said device and wherein the method further comprises the step of operating the device in a reduced mode in which at first a part of the data stored in said first memory means and being necessary for running the reduced mode is identified and copied into said second memory means of said device and the operation of said device in said reduced mode is basically carried out only on the basis of the data contained in said second memory means.

The solution in accordance with the present invention provides the possibility of updating the data or software contained in the first memory means while a basic functionality of the device is still maintained. Thus, in contrast to present solutions used for updating the software—for example—of a mobile phone, the phone can still be used during FOTA or another service having influence on the content of the data.

The present invention however is not reduced to the scenario of updating the software contained in the first memory means. The reduced mode for operating the device might also be selected in other situations. In particular, this inventive feature might also be useful in case that the power consumption of the device has to be temporarily reduced. For example, in case the battery level is low and the user of the device still wants to keep the device working but with a limited set of functionality, a specific power reduction reduced mode might be selected which still provides the basic functionality of the device but reduces the power consumption by not providing other functionality.

Thus, in accordance with a preferred embodiment of the present invention, a plurality of reduced modes is selectable wherein the data copied from said first memory means to said second memory means depend on the reduced mode that has been selected. In particular, the functionality of said device might be reduced to a specific function depending on the reduced mode selected.

While executing the device in the reduced mode, an access to the first memory means is preferably restricted. Thus, the central processing unit only uses the data contained in the second memory means. However, an access to specific parts of the first memory means might still be allowed. In this case, the first memory means preferably comprises an area containing user content data—e.g., MP3-files or the like—that might also be accessed by the CPU. At the same time, the data of said first memory means might be accessed by an update service in order to update the software and/or functionality of the device. When the reduced mode is again left, the normal execution mode might be initiated by synchronising the data contained in the second memory means with the data of the first memory means in case the data have been amended.

Preferably, the first memory means is a flash memory, a USB memory device, a hard drive or a comparable memory means while the second memory means is a random access memory (RAM).

Accordingly, the present invention provides a possibility of allowing the user of a device to use still a limited set of functions while the data contained in the memory of the device can be updated. Thus, it is possible to make a phone call or listen to music in a mobile phone while the remaining software is being upgraded via FOTA or another service. In contrast to today's solutions wherein no functionality at all is available during the software update, the present invention provides a significant improvement.

### BRIEF DESCRIPTION OF THE DRAWINGS

The above-mentioned aspects as well as other aspects, advantages and novel features of the present invention will become apparent upon reading the following detailed description with reference to the accompanying drawings.

FIG. 1 shows a mobile phone providing a plurality of reduced modes in accordance with the present invention;

FIG. 2 is a block diagram illustrating the different steps of operating the mobile phone of FIG. 1 in a reduced mode;

FIG. 3 is a schematic view showing the handling of data stored in the different memory means during a first reduced mode and

FIG. 4 shows the data handling during a second reduced mode.

### DETAILED DESCRIPTION OF EMBODIMENT

In the following, the present invention is explained with reference to a mobile phone which represents a preferred embodiment of the present invention. Nevertheless, it has to be emphasised that the concept of the present invention is not reduced to mobile phones but might also be used with other devices that are controlled by a processor, e.g., other communication and/or multimedia devices. Generally, the inventive concept of providing a reduced mode might always be useful in case the software of the device has to be updated from time to time or the power consumption has to be temporarily reduced.

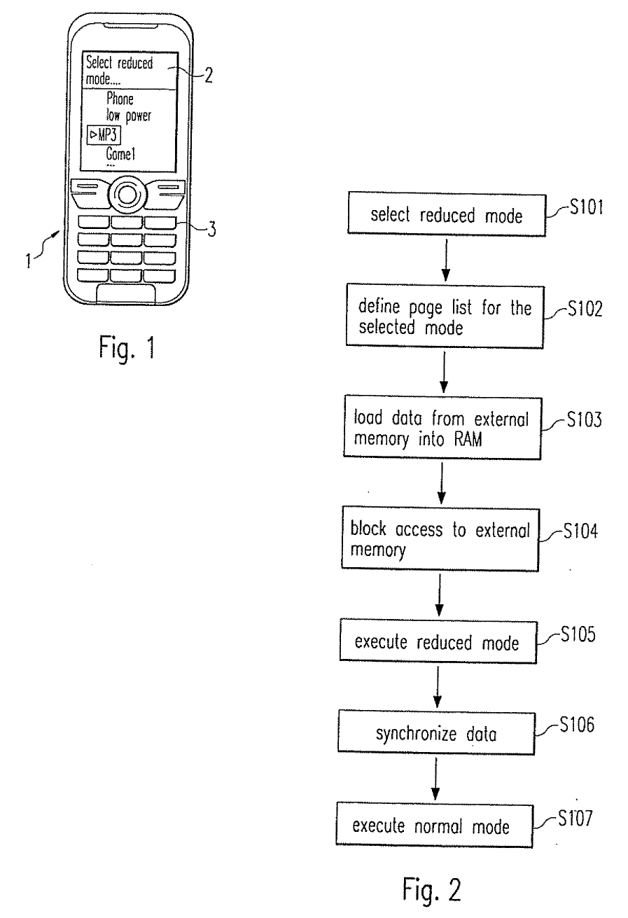

The mobile phone 1 shown in FIG. 1 provides a plurality of functions being related to communication services and other multimedia applications. Thus, besides for making phone calls, the mobile phone 1 might also be used for playing games or as an MP3 music player. Furthermore, also a camera function might be provided by integrating a digital camera within the phone or connecting the phone 1 to an external camera device.

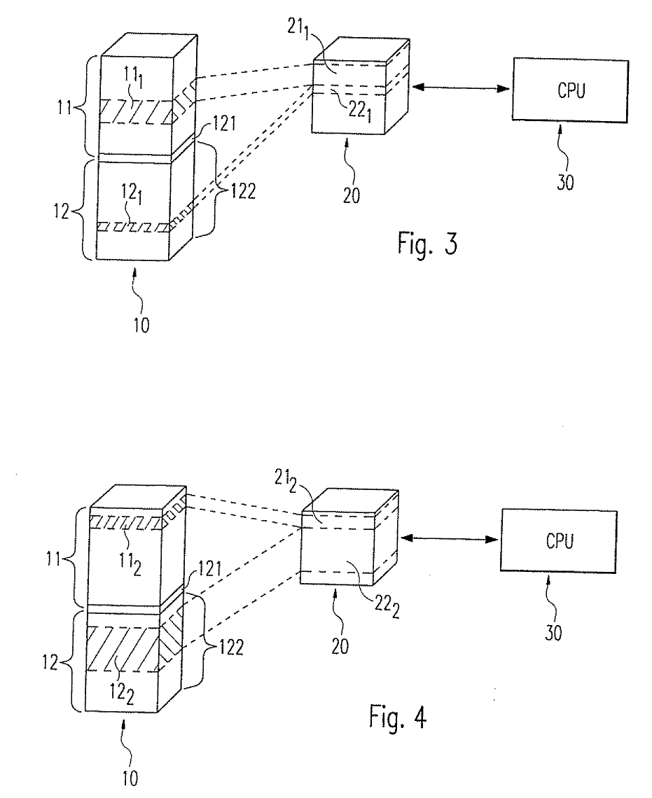

The different applications of the mobile phone 1 are controlled by a central processing unit 30 shown in FIG. 3. This central processing unit 30 operates the phone 1 on the basis of data stored in two memory means. As schematically shown in FIG. 3, the mobile phone comprises first memory means 10 and second memory means 20. The first memory means 10 is the main memory of the mobile phone 1 and is sub-divided in two parts 11 and 12. The first part 11 is the code section comprising the execution code for the different applications of the mobile phone 1. When running a specific application of the mobile phone 1, the central processing unit 30 executes the code being related to the selected application. The second part of the main memory 10 is the data section 12 comprising additional data also being related to the different applications. In contrast to the data stored in the code section 11, the data of the data section 12 do not represent execution code but represent additional data being necessary for running the applications. For example, the data section 12 might comprise audio data which are play-backed when the audio player function of the mobile phone is selected.

As shown in FIGS. 3 and 4, the data section is again sub-divided in a system part 121 and a user content part 122. While the user content part 122 contains the additional data mentioned above in one file system partition, the system part 121 comprises e.g. system settings and other system files in a separate file system partition. Furthermore, this system part 121 also comprises a look-up table containing information being necessary in order to identify the data being necessary for running a reduced mode. The function of this look-up table is explained in more detail below.

The first memory means 10 is also called external memory and might be represented by a flash memory, a USB memory device, a hard drive or another comparable memory device.

Additionally, the mobile phone comprises a second memory 20 which is preferably represented by a random access memory (RAM). Said random access memory 20 might be used in order to copy data from the first memory means 10 that are repeatedly used by the central processing unit 30. The RAM 20 allows a faster access to the stored data and therefore helps to improve the performance of the whole mobile phone 1.

Thus, during a standard operation of the mobile phone 1, the central processing unit 30 mainly accesses the RAM 20 in order to execute the code stored therein. Nevertheless, also the data stored in the first memory means 10 are accessed by the central processing unit 30 in order to run the mobile phone. Accordingly, the operation of the mobile phone 1 in the standard mode carried out on the basis of all data stored in the first memory means 10.

From time to time, the data stored in the first memory means 10 must be updated in order to upgrade the functionality of the mobile phone 1. By updating the data contained in said first memory means 10, the functionality of the mobile phone 1 might be improved or new applications might be made available for a user of the phone 1. This update might in particular take place in the form of a firmware update over the air (FOTA) wherein the data contained in the code section 11 of the main memory 10 are replaced by new data that are wirelessly transmitted. In this way, the software controlling the function of the mobile phone 1 is renewed.

Up to now, the mobile phone 1 had to be discontinued from the standard operation during such a software update. However, depending on the kind of memory used for the first memory means 10, the user had to wait for a relatively long time until the mobile phone 1 was again useable.

In order to avoid this problem, a specific method of operating the mobile phone 1 is introduced in accordance with the present invention which will be explained in the following.

The present invention is based on the idea of providing a reduced operation mode wherein a subset of the first memory means 10 is copied into the second memory means 20 and an access to the first memory means 10 is restricted. During the reduced mode, the operation of the mobile phone 1 is basically carried out on the basis of the data stored in the second memory means 20. Since the storage space of the second memory means 20 is considerably smaller than the storage space of the first memory means 10, the functionality of the mobile phone 1 must most likely be restricted. Nevertheless, at least a few functions are still available to the user of the phone 1 during this inventive reduced mode.

According to a preferred embodiment of the present invention, a plurality of different reduced modes is available. As shown in FIG. 1, the user of the phone 1 is able to choose—e.g., by using the keypad 3—between different reduced modes that provide different functionality. As it will be recognized by a person skilled in the art, other ways of selecting a reduced mode—for example voice control etc.—might also be used. A first mode “Phone” shown on the display 2 of the phone 1 might for example be selected in order to maintain the wireless communication applications during the reduced mode. Another mode “Game 1” might e.g. be used in order to play a specific game while a third reduced mode provides the functionality of an MP3-player in order to listen to music during the reduced mode. As further shown in FIG. 1, another so-called “low Power” mode might be selected in order to reduce the power consumption of the mobile phone 1. In this specific mode, only applications are available which do not require a high amount of power. For example, a camera function of the phone 1 might be disabled during this reduced power mode.

As mentioned above, a specific feature of the reduced mode is that the operation of the mobile phone 1 is carried out basically on the basis of data stored in the second memory means, i.e. in the RAM 20. Thus, depending on the reduced mode selected, specific data have to be transferred from the first memory means 10 into the RAM 20. The rules for the selection of the data can be implemented during the development of the mobile phone 1 and can be obtained either by analysis or by experimentation. This information is stored in the look-up table mentioned above and allows the system to identify the data that have to be copied to the second memory means.

It is a specific feature of the present invention that the data that are necessary for running a reduced mode are identified at the initiation of the reduced mode. In contrast to the known method of demand paging, an access to additional data afterwards in order to continue the operation of the device is not necessary.

After the data have been copied into the RAM 20, the access to the first memory means is restricted. Now, the mobile phone 1 is in the reduced mode wherein the central processing unit 30 controls the operation of the phone 1 only on the basis of the data stored in the RAM 20. As mentioned above, a limited functionality of the phone 1 might be available depending on the reduced mode selected. For example, the phone might be in an idle mode, might be used as a music player or for playing games. This reduced mode, however, is not necessarily a subset of the normal functionality of the phone. It would also be possible to use specifically designed software for this reduced mode.

While the phone 1 is operated in the reduced mode, an access to the blocked memory 10 is usually forbidden as mentioned above. Under specific circumstances, however, it might be possible to leave the reduced mode in order to fetch more data from the first memory means 10 and to return to the reduced mode afterwards. For example, the CPU 30 might access data contained in the user content part 122 of the data section 12 in order to play a specific music file. Further, in case the software of the device is not being updated during the reduced mode, an additional fetching of data (also from the code section 11) might also be allowed. Nevertheless, this temporary quitting of the reduced mode in order to read or write data might also be completely forbidden. In particular, the CPU 30 will not be allowed to access data contained in the system part 121. In case it is not possible to leave the reduced mode, the user of the phone 1 is notified in case he initiates an action that would require the access to data stored in the first memory means 10. In this case, on the display 2 of the phone information would be shown informing the user of the restrictions of the current execution mode.

However, during this reduced mode, the data stored in the first memory might be accessed and updated via FOTA or another service. Thus, the user is still able to use the applications provided by the selected reduced mode while the firmware of the phone is updated. In contrast to solutions known in the prior art, it is therefore still possible to use the phone 1.

Finally, when the reduced mode is left by the user in order to enter the normal operation mode of the phone 1, the data stored in the first memory 10 means must probably be synchronised with the data of the RAM 20, e.g., call lists or the file systems must be updated. In case the software of the phone 1 has been updated during the reduced mode, the phone 1 may—if required—afterwards be re-booted in order to execute the new software.

The different steps of the present invention of operating a device in a reduced mode are shown in FIG. 2. As mentioned above, in a first step S101 a reduced mode is selected. In case only a single reduced mode is available, the user of the mobile phone 1 simply has to initiate this reduced mode. In case a plurality of different reduced modes is available as shown in FIG. 1, the user has to select one reduced mode offering the application(s) desired.

After the reduced mode has been selected, a page list is defined for the selected mode in step S102. As shown in FIGS. 3 and 4, the data necessary in order to carry out the selected reduced mode are identified by using the look-up table. In FIG. 3, a first data block 11₁ from the code section 11 and a data block 12₁ from the data section are identified wherein the data contained in both blocks 11₁ and 12₁ are necessary in order to carry out the application provided by the selected reduced mode. In FIG. 4 however, two other data blocks 11₂ and 12₂ are selected that belong to a different application since another reduced mode has been selected.

Referring again to FIG. 2, in the following step S103 the data selected in step S102 are copied from the first memory means 10 to the second memory means 20 forming there new data blocks 21₁, 22₁ and 21₂, 22₂. Afterwards, the access to the first memory 10 is restricted for the CPU 30.

The reduced mode is now executed in the following step S105. In this mode, the central processing unit 30 controls the operation of the mobile phone 1 only on the basis only of data stored in the second memory means 20. During this reduced mode, it is, however, still possible to amend the data in the first memory means 10. In this way, during the execution of the reduced mode, these data might be updated by FOTA or another service. Further, as already mentioned above, it might be possible to temporarily leave the reduced mode in order to fetch more data from the first memory means 10. However, usually the CPU 30 only accesses the data contained in the RAM 20.

After the reduced mode is left, a synchronisation of the data stored in the first memory means 10 might be necessary. In this case, the data contained in the RAM 20 are again transferred into the corresponding data blocks of the first memory means 10. In this way, call lists or file systems may be updated that have been amended during the execution of the reduced mode.

After the synchronisation in step S106, the mobile phone is again operated in the normal mode in step S107. Depending on the reason for entering the reduced execution mode, it might be necessary to re-boot the mobile phone 1. This might in particular be necessary in case the remaining data have been updated in order to carry out an update of the firmware.

As already mentioned above, the present invention is not restricted to the use of mobile phones. Instead, in all cases the software of an electronic device has to be updated, the present invention might be useful in order to provide a reduced functionality during the update process. The present solution opens a new possibility to allow a user to still use a limited set of functionality while the software is being upgraded via an FOTA or another service. Additionally, the present invention might also be useful in case there is a need for a temporary reduction of the power consumption, e.g. when the battery level is low and the user would like to keep the device working but with a limited set of functionality.

1-22. (canceled)

23. A method of operating a processor controlled device, comprising:
operating in a standard mode corresponding to data that is stored in a flash memory device and/or a random access memory (RAM) of the processor controlled device;
operating in a reduced mode by copying, into the RAM, a first portion of data stored in the flash memory device and exclusively operating the processor controlled device on the data in the RAM,
wherein the flash memory device comprises an area containing user content data that may be accessed in the reduced mode.

24. The method of claim 23, wherein operating in the reduced mode comprises operating the processor controlled device on data in the RAM while operating instructions in the flash memory are upgraded.

25. A processor controlled device, comprising
a first memory comprising a user content data area;
a second memory; and
a central processing unit configured to control operation of the processor controlled device in one of a plurality of operation modes including a standard mode and a reduced mode,
wherein, in a standard mode, an operation of the device is carried out corresponding to data stored in first and/or second memory,
wherein, in a reduced mode, the central processing unit is further configured to copy a portion of the data stored in the first memory into the second memory,
wherein the portion of the data copied into the second memory is identified at an initiation of the reduced mode,
wherein the operation of the device in the reduced mode corresponds to the portion of the data stored in the second memory, and
wherein the central processing unit is further configured to include read and write access to the user content data area in the reduced mode.

26. The processor controlled device of claim 25, wherein the reduced mode comprises a plurality of reduced modes that are selectable, wherein the portion of the data copied from the first memory to the second memory depends on which of a plurality of reduced modes is selected.

27. The processor controlled device of claim 25, wherein the portion of the data copied into the second memory is identified corresponding to information stored in one of the first memory and a second memory.

28. The processor controlled device of claim 27, wherein one of the first memory and the second memory comprises a look-up table that is configured to assign data blocks corresponding to the first memory to at least one of a plurality of reduced modes.

29. The processor controlled device of claim 28, wherein the look-up table is configured to contain information that is defined during a development step of the processor controlled device.

30. The processor controlled device of claim 25 wherein a functionality of the processor controlled device is reduced corresponding to the reduced mode.

31. The processor controlled device of claim 25, wherein functionality of the processor controlled device is limited to a specific function of the processor controlled device corresponding to the reduced mode.

32. The processor controlled device of claim 25, wherein at least a portion of the data stored in the first memory is updated during the reduced mode.

33. The processor controlled device of claim 25, wherein the second memory comprises a random access memory (RAM).

34. The processor controlled device of claim 25, wherein the first memory comprises a flash memory, a universal serial bus (USB) memory device and/or a hard drive.

35. The processor controlled device of claim 25, further comprising a mobile telephone.

36. A method of operating a processor controlled device, comprising:
operating in a standard mode corresponding to data that is stored in a first memory and/or a second memory of the processor controlled device;
operating in a reduced mode by copying, into the second memory, a first portion of data stored in the first memory and exclusively operating the processor controlled device based on the data in the second memory,
wherein the first memory comprises an area containing user content data that may be accessed in the reduced mode.

37. The method of claim 36, wherein the reduced mode comprises a plurality of reduced modes that are selectable and wherein the first portion of data copied from the first memory to the second memory is responsive to which of the plurality of reduced modes is selected.

38. The method of claim 36, identification of the first portion of data corresponds to information contained in one of the first memory or the second memory.

39. The method of claim 38, further comprising assigning data blocks of the first memory to the reduced mode responsive to a look-up table in one of the first memory or the second memory.

40. The method of claim 39, further comprising defining information in the look-up table during a development step of the processor controlled device.

41. The method of claim 35, further comprising reducing functionality of the processor controlled device in the reduced mode.

42. The method of claim 36, further comprising limiting functionality of the processor controlled device to a specific function in the reduced mode.

43. The method of claim 36, further comprising updating at least a portion of data stored in the first memory in the reduced mode.

44. The method of claim 36, wherein the second memory comprises a random access memory (RAM).

45. The method of claim 36, wherein the first memory comprises a flash memory, a universal memory (USB) device and/or a hard drive.

46. The method of claim 36, wherein the processor controlled device comprises a mobile telephone.
